(19) United States
(12) Patent Application Publication
(10) Pub. No.: US 2008/0296368 A1
(43) Pub. Date: Dec. 4, 2008

(54) Stored-value instrument protection system and method

(76) Inventor: Victor V. Newsom, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/810,302

(22) Filed: Jun. 4, 2007

(51) Int. Cl. G06K 5/00

(52) U.S. Cl. 235/380

(57) ABSTRACT

A system and method are disclosed for protecting funds associated with a stored-value instrument, such as a gift card, by way of a non-limiting example. The system and method provide an ability to assign a deactivated status to a stored-value instrument in response to a deactivation request. The system and method further provide an ability to change the status of a deactivated instrument in response to a reactivation request. The reactivation request includes reactivation information assigned for the instrument in response to the deactivation request. The system and method maintain information on the status of an instrument, which status can be used as part of an authorization process to authorize a transaction in which the instrument is used. The system and method may further include registration of instrument holders, such as an instrument's transferor and/or transferee, which information can be used for marketing purposes by an entity to customize offers to be made to an instrument holder or for other purposes such as business intelligence.

### FIELD OF THE INVENTION

The present invention relates to a method and system for protecting an instrument, such as a gift card or other stored-value instrument, used in accessing a preset balance of funds, and more particularly, for protecting an instrument activated for use in accessing the funds by deactivating the instrument after it has been activated and then reactivating the instrument, such deactivation and reactivation being performed by one or more authorized persons, and such deactivation lasting for a period of time, such as a time during which the instrument is being forwarded to a recipient.

### BACKGROUND OF THE INVENTION

As the popularity of gift cards (or other stored-value instruments), increases, the potential for unintended use of a gift card also increases. In a typical scenario, a person, i.e., a gift card purchaser purchases a gift card from a given entity, i.e., a gift card issuer or issuer, to give to another person, i.e., an intended recipient. The gift card has some amount of money prepaid, i.e., a prepaid balance, which enables the gift card to be used, up to the prepaid balance, to purchase goods and/or services. The gift card is usually activated at, or prior to, the purchase or delivery.

In most cases, a gift card is handled in a manner similar to cash, i.e., anyone holding the gift card is able to tender it as payment. Like cash, a gift card can be transferred from one person to the next, in most cases without any need to notify the card's issuer. Thus, the issuer's visibility concerning the transfer is at best limited.

In addition, like cash, an activated gift card can be used by anyone who presents the card (e.g., in a brick and mortar transaction), or who presents the card's information (e.g., an online transaction). This makes the gift card susceptible to fraudulent use. If the gift card is lost or stolen, the rightful cardholder can be held to bear at least some of the loss due to unauthorized use of the card. Thus, even in a case that a card issuer issues a replacement card upon notification of the lost or stolen card, the card issuer will typically not issue a refind for any fraudulent use of the card prior to notification. In other words, the replacement card's prepaid balance will typically be debited any amount expended as a result of a fraudulent use that occurs prior to notification that the card was lost or stolen.

Conventionally, a gift card purchaser purchases a gift card that is activated prior to or at the time of the purchase (in the case of cards purchased on via the internet—these cards are often sent directly to the purchaser and activated after delivery but before they are sent to the recipient). Many times, the gift cards are put on display for customers to inspect prior to purchasing. This practice also makes the cards accessible to scam artists who can record gift card information, such as the card security code (CSC), also referred to as the card verification code or value (CVV or CVC), before the gift cards are purchased. This information can be used with activated gift cards to make fraudulent purchases, or otherwise access the available fund balance associated with these gift cards.

A gift card holder may wish to send an activated gift card to a recipient, so that the recipient can use some or all of the remaining prepaid balance. The gift card holder may wish to share the gift card with a relative or friend, for example. Alternatively, there are one or more online gift card trading marketplaces, whereby a gift card holder can trade or sell a gift card to someone.

FIG. 1 illustrates a flow in which a purchaser forwards an activated card to recipient. In step 101, the purchaser obtains an activated gift card. At step 102 the purchaser forwards the activated card to the recipient. In a desired situation, the recipient receives the activated gift card at step 103. A gift card is particularly vulnerable in transmit. For example, an envelope, or package, containing the gift card could fall into the wrong hands, e.g., the gift card might be lost or stolen in transmit. While the card is in transmit, the actual location of the card may be unknown for some period of time. In order to take advantage of the lack of knowledge as to the location of the card, a fraudulent user is most likely to use the activated gift card immediately in order to gain access to the prepaid balance before either the purchaser or the recipient becomes aware that the gift card has fallen into the wrong hands. In the case that the card reaches an unintended recipient who uses the remaining prepaid balance before the card issuer is notified, the rightful cardholder is likely to bear the full loss due to the fraudulent use.

Furthermore, there is no incentive for the purchaser or intended recipient to notify the gift card issuer of the transfer. Thus, the gift card issuer has little, if any, visibility into the transfer, and most gift card transfers are not traceable.

An improved method and system for gift card protection is desired that allows an activated gift card to be deactivated and a deactivated gift card to be reactivated, such deactivation and reactivation to be performed by authorized persons.

### SUMMARY OF THE INVENTION

In accordance with embodiments of the present disclosure, a method and system is provided for protecting a stored-value, such as a gift card or other card having a prepaid balance, and the funds associated with the instrument, in which an activated instrument can be deactivated, and a deactivated instrument can be reactivated. In accordance with disclosed embodiments, such deactivation and reactivation is performed by one or more authorized requesters.

In accordance with one or more disclosed embodiments, a system and method provide an ability to assign a deactivated status to an instrument in response to a deactivation request. The system and method further provide an ability to change the status of a deactivated instrument in response to a reactivation request. The reactivation request includes reactivation information assigned for the instrument in response to the deactivation request. In accordance with embodiments disclosed, the system and method maintain information on the status of an instrument, which status can be used as part of an authorization process to authorize a transaction in which the instrument is used.

In accordance with one or more embodiments presently disclosed, the system and method can further include registration of instrument holders, such as an instrument's transferor and/or transferee, which information can be used for marketing purposes by an entity to customize offers to be made to an instrument holder, or other parties such as a potential instrument holder. Collected information can be used to provide business intelligence to merchants, or other parties. For example, business intelligence can include information to identify an instrument transfer and demographic information associated with registered users, e.g., users registration performed as part of deactivation and/or reactivation.

In one embodiment of the invention, the method of protecting a stored-value instrument used to access a balance of funds associated with the instrument. In accordance with the method, in response to a request to deactivate a stored-value instrument, a deactivated status is set for the instrument, and reactivation information is assigned. The reactivation information is for use in reactivating the deactivated instrument. In response to a request to reactivate the deactivated instrument, a determination is made whether or not reactivation information received with the reactivation request corresponds with the reactivation information assigned in deactivating the instrument. An activated status is set for the instrument in a case that a determined correspondence exists between the assigned and received reactivation information.

In accordance with one or more embodiments, information about a request can be obtained. The obtained information can be used to make one or more offers to the requester by an entity receiving the deactivation or reactivation request and/or an entity who issues or sells the instrument, for example.

In accordance with one or more embodiments, deactivation can be performed at a time that the instrument is purchased, or otherwise legitimately acquired. The reactivation request and the deactivation request can be initiated by the same or different requesters.

In accordance with one or more embodiments, the deactivation request is initiated by, or on behalf of the instrument's purchaser, or holder, and in anticipation of a transfer of the instrument to an intended recipient. Once the instrument is received by the intended recipient, a request is initiated to reactivate the instrument. The request can be initiated by the instrument's purchaser (or holder) or the intended recipient, for example.

In one or more embodiments, a system is provided for protecting a stored-value instrument used to access a balance of funds associated with the instrument. The system includes one or more computing devices running a machine executable code. In response to a request to deactivate a stored-value instrument, the code is configured to perform the steps of setting a deactivated status for the instrument, and assigning reactivation information. In response to a request to reactivate the deactivated instrument, the code is configured to perform the steps of determining whether or not reactivation information received with the reactivation request corresponds with the reactivation information assigned in deactivating the instrument, and setting an activated status for the instrument in a case that a determined correspondence exists between the assigned and received reactivation information.

Further objects, features, and advantages of the presently-disclosed embodiments over the prior art will become apparent from the detailed description of the preferred embodiments which follows, when considered with the accompanying figures.

### BRIEF DESCRIPTION OF THE DRAWINGS

FIG. 1 is a flow diagram illustrating a conventional method in which a purchaser forwards an activated card to recipient;

FIG. 2 is a schematic diagram illustrating an example of a deactivation/reactivation flow in accordance with one or more disclosed embodiments;

FIG. 3 is a schematic diagram illustrating components of a system for use in protecting a gift card used in commerce in accordance with one or more disclosed embodiments;

FIG. 4 is a flow diagram illustrating process steps for transferring a card protected in accordance with one or more disclosed embodiments;

FIG. 5 is a flow diagram illustrating process steps for use in reactivating a deactivated card in accordance with one or more embodiments of the present disclosure;

FIG. 6 is a flow diagram illustrating process steps for a computing device in response to a deactivation or reactivation request in accordance with one or more embodiments of the present disclosure;

FIG. 7, which comprises FIGS. 7A and 7B, is a flow diagram illustrating process steps for use in authenticating a deactivation request or a reactivation request in accordance with one or more embodiments of the present disclosure; and

FIG. 8 is a flow diagram illustrating processing steps for use in authorizing a transaction involving a card using a card status set in accordance with one or more embodiments of the present disclosure.

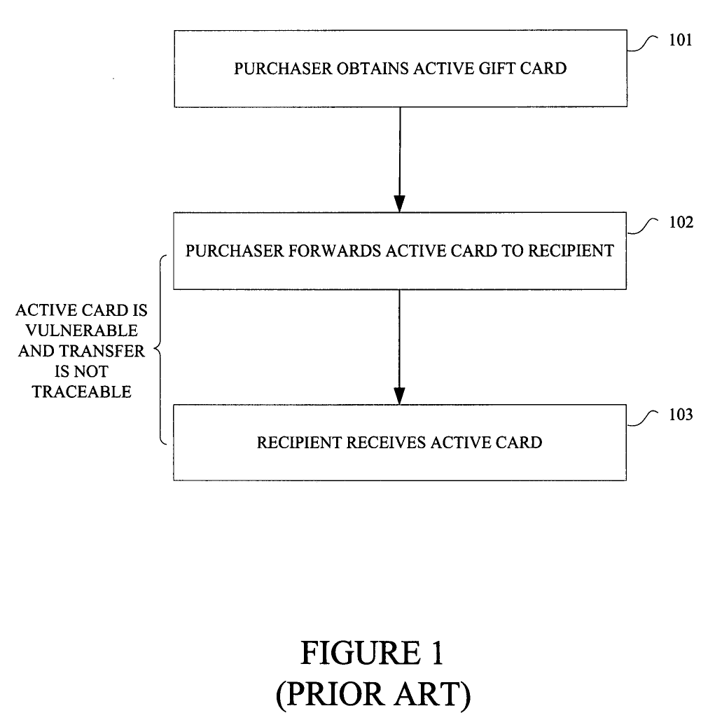

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the disclosure.

While embodiments are described with reference to a stored-value instrument in the form of a gift card, it should be apparent that embodiments of the present disclosure can be practiced with other types of card instruments, such as cash, credit and debit cards. By way of further non-limiting examples and while an instrument can take the form of a plastic card, other forms are contemplated including such physical forms as paper, fob, mini card, smartcard, token, computer-readable medium (e.g., compact Flash, USB Flash, SD card, compact disc, etc.), and the like. Other forms, including electronic forms, are also contemplated.

In accordance with embodiments of the present disclosure, a method and system is provided for protecting a stored-value instrument, such as gift card or a card having a prepaid balance of funds, and the funds associated with the card, in which an activated card can be deactivated, and a deactivated card can be reactivated. In accordance with disclosed embodiments, such deactivation and reactivation is performed by one or more authorized requesters. In accordance with one or more embodiments, the card is pre-funded, such as in a case of a gift card with a prepaid balance of funds. In accordance with embodiments disclosed, a value associated with an instrument, e.g., a prepaid (or pre-funded) balance, can be identified from the instrument itself or with reference to a data store remote to the instrument. While embodiments of the invention can be practiced with a single-load instrument (e.g., an instrument one prepaid balance), an instrument having a re-loadable balance is also contemplated.

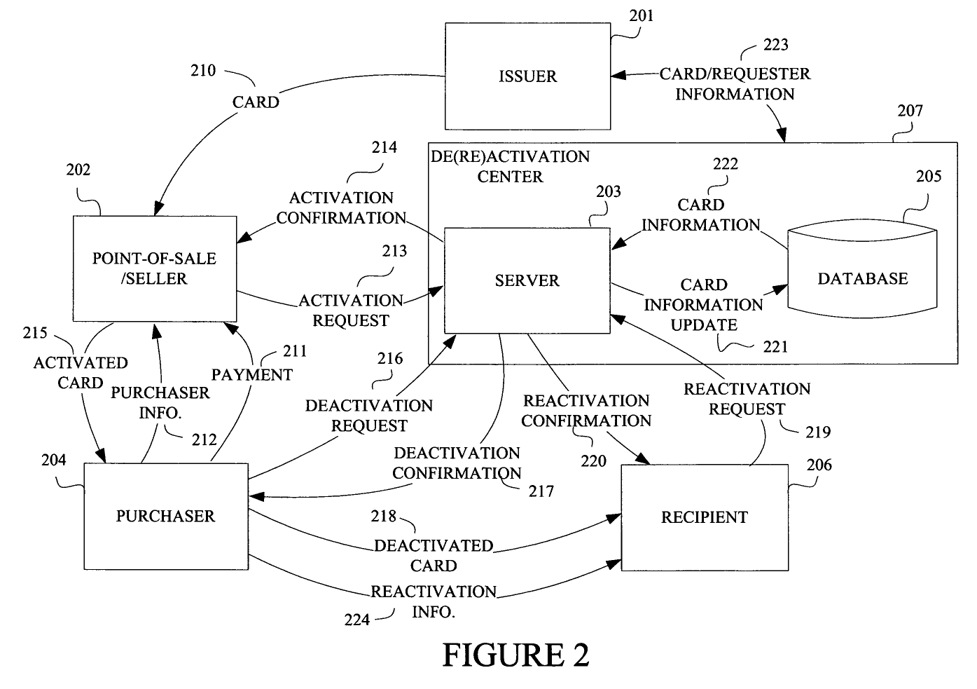

One embodiment of the present disclosure is a system and method of protecting an activated instrument, such as a gift card. FIG. 2 schematically illustrates various relationships and transactions between various entities in accordance with the method and system. In one embodiment, these entities comprise one or more gift card issuers 201, one or more point-of-sale (POS) gift card sellers 202, one or more gift card purchasers 204, one or more gift card recipients 206, and one or more de(re)activation processing centers 207.

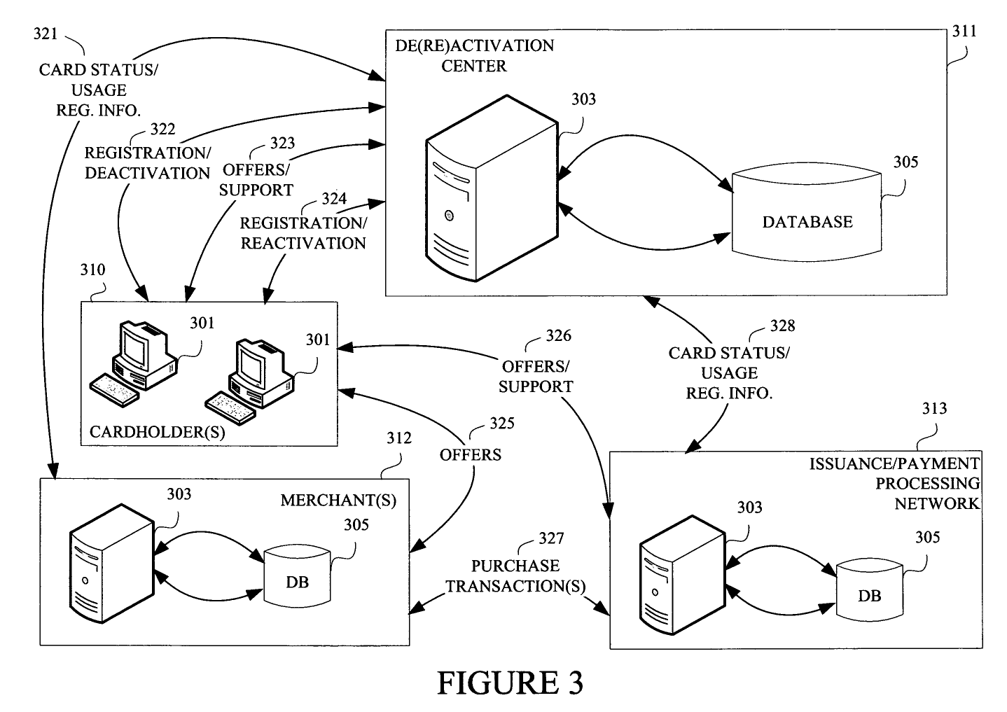

A gift card issuer 201 can be an entity who is part of an issuance/payment processing network (n.b., such network is discussed in more detail with reference to FIG. 3). As is discussed below, issuer 201 and processing center 207 can be, but need not be, the same entity. The gift card issuer 201 has a gift card program in which gift cards are issued, or otherwise made available, for use by card purchasers. In accordance with one or more embodiments, such gift card programs usually offer gift cards, each card having an associated stored value (also referred to herein as a prepaid balance) and capable of being purchased for the amount of the stored value and some additional fees. In some cases, once the amount of the prepaid balance has been expended, the card becomes invalid. In other cases, the gift card can be “reloaded”, whereby additional funds can be purchased to increase, or otherwise supplement, the prepaid balance.

In accordance with at least one embodiment, the gift cards issued by one or more gift card issuers 201 are supplied 210 to a gift card seller 202. The gift card seller 202 can be a point-of-sale seller, such as a brick and mortar establishment or an online establishment, for example. The gift card seller 202 and issuer 201 can be the same entity or different entities. In any case, the gift cards received by seller 202 can either be activated at the time that the cards are received by the seller 202, or activated at the time of purchase by purchaser 204. In a case that seller 202 is an online establishment, the gift card can be sent to the purchaser 204 and activated after receipt by the purchaser 204. In the example shown in FIG. 2, a gift card is supplied 210 from the issuer 201 to the seller 202 in a deactivated state, and is activated at the time of purchase.

To activate the gift card, seller 202 transmits an activation request 213 to processing center 207. In accordance with one or more embodiments, purchaser 204 provides payment 211 to seller 202 to purchase the gift card and receives 215 an activated card. In accordance with one or more embodiments, the purchaser 204 may optionally provide purchaser information 212. Alternatively, purchaser information 212 may already be available, e.g., known to the seller 202. In a case that the seller 202 has, or receives, purchaser information from the purchaser 212, such information can be forwarded with information identifying the gift card (as discussed below) being purchased as part of the activation request 213. An activation confirmation 214 is forwarded from processing center 207 to seller 202 in response to the activation request 213. Furthermore, in response to the activation request 213, an activated status of the card is set in database 205.

In accordance with one or more embodiments, there can be one or more processing centers 207, each of which comprises at least one server 203 coupled to at least one database 205. Server 203 communicates with database 205 to store and/or retrieve information, which information includes a status for a given gift card, which status information identifies whether a given gift card is currently activated or deactivated. In addition to the gift card's activation status, the database 205 may also comprise one or more entries, e.g., one or more fields and records, for each gift card for which processing center 207 retains status information. The record maintained for a given gift card in database 205 can include one or more fields to identify the given gift card (e.g., a gift card number assigned by the issuer 201, which can include any number of digits or characters and may include additional validation indicators, such as a four digit validation number). In addition, database 205 can include an expiration date and/or a dollar amount identifying the available funds associated with the card. The database 205 may also include information about a registrant, e.g., an entity, such as purchaser 204 and/or recipient 206, for whom the gift card is activated or deactivated. Authentication information, e.g., reactivation information such as a password, pass code, etc., associated with the gift card can also be stored in database 205, or otherwise accessible to processing center 207. Information stored in database 205 can be used to provide a degree of security not otherwise available for the gift card.

Embodiments presently disclosed permit a gift card holder to deactivate an activated gift card. Such deactivation can be performed on an otherwise active card. An active card includes a card which is valid for use in accessing some amount of funds associated with the card. An example of an active card is a card issued by issuer 201 that has not yet expired and/or has some amount of funds available. In accordance with one or more embodiments, processing center 207 can receive a deactivation request 216 from purchaser 204, for example. It should be apparent that a deactivation request 216 can be received from an entity other than purchaser 204. For example, the deactivation request can be initiated by issuer 201 or seller 202. In accordance with one or more embodiments, a deactivation request can be performed by any valid requester, including a person to whom a card is transferred, e.g., recipient 206 or a subsequent transferee. Likewise, the deactivation request can be made at the time the card is purchased or obtained, or at a later time, such as before a card is to be forwarded or transferred to another party.

Deactivation request 216 can include information to validate the request and/or that the requester, e.g., purchaser 204, is authorized to make the request. For example, the deactivation request 216 can include a password, pass code, etc. associated with the gift card to be deactivated. By way of a further non-limiting example, deactivation request 216 can include personal information for the requester. In the case of the purchaser 204, the deactivation request 216 can include some or all of purchaser information 212 supplied to processing center 207 as part of the activation request 213, for example.

In response to the deactivation request 216, processing center 207 deactivates the gift card, and assigns reactivation information for use in reactivating the gift card. Although referred to herein as a pass code or password, information used to authenticate or verify a deactivation request (or requester) or a reactivation request (or requester) can take any of a variety of forms useful in verifying the request and/or the requester. In addition and by way of a non-limiting example, authentication information can be based on a password or other information supplied by purchaser 204, or can be generated by server 203 of processing center 207, e.g., randomly generated, generated based on information supplied by purchaser 204 or some combination. By way of a further non-limiting example, the authentication information can include personal information of the entity requesting deactivation and/or the entity requesting reactivation.

In accordance with one or more embodiments, the authentication information used in reactivation is different from any password or the PIN (e.g., the PIN used in authorization of a transaction, such as a purchase, in which the card is used) previously assigned for the gift card, which provides increased security for the card. In accordance with such embodiments, a reactivation pass code is different from the transaction authorization PIN assigned to the card, and different from an assigned activation pass code, such that the transaction authorization PIN and/or the activation pass code cannot be used to reactivate a deactivated gift card; thus adding to the security associated with the card. In response to the deactivation request 216, server 203 updates 221 the card information stored in database 205 to store the reactivation pass code, and forwards 217 confirmation of the deactivation to purchaser 204. The deactivation confirmation 217 can include the reactivation pass code.

As is discussed in more detail below, the status of a gift card maintained in database 205 can be used as part of a payment authorization process. Thus, in a case that the gift card has been deactivated, the status information maintained in database 205 can be used to decline authorization in connection with a transaction in which the gift card is used. Once deactivated, funds that would otherwise be available are made unavailable, until the gift card is reactivated.

In the example shown in FIG. 2, the purchaser 204 transfers 218 the deactivated gift card to a recipient 206. In accordance with one or more embodiments, and the example shown in FIG. 2, the recipient 206 reactivates the gift card. In accordance with such embodiments, the purchaser 204 preferably forwards 224 the information needed for reactivation of the gift card separate from the transfer 218 of the gift card. In so doing, if the gift card is lost or stolen during transmit, it cannot be used to access any remaining funds, since the card is deactivated.

Once the gift card is received by the recipient 206, the recipient initiates a reactivation request 219, which can include the reactivation information, e.g., the reactivation pass code. In response, server 203 retrieves 222 card information, including the reactivation pass code assigned as part of the deactivation, stored in database 205. Using the retrieved card information, server 203 authenticates the reactivation request 219, and/or the reactivation requester. For example, server 203 compares a reactivation pass code received in the reactivation request 219 with the stored reactivation request retrieved 222 from the database 205. If the received reactivation pass code and the stored reactivation pass code correspond, e.g., are equal, server 203 updates 221 the card information in database 205 to reactivate the gift card. Once reactivated, the gift card can be used, e.g., any available funds associated with the gift card are accessible. The server 203 forwards confirmation 220 of the reactivation.

Of course, it should be apparent that a denial of a deactivation request 216, or denial of a reactivation request 219, can be sent in place of the deactivation confirmation 217, or the reactivation request 219, in a case that the server 203 is unable to authenticate the request, and/or the requester.

In accordance with one more embodiments, information supplied by a deactivation requester, or by a reactivation requester, can be used to identify one or more offers that may appeal to the requester, as identified by demographic information (e.g., age, gender, geographic location, etc.) or other information supplied by the requester, for example. Such offers can be made by the processing center 207 on behalf of itself or another party (e.g., the issuer 201 and/or the seller 202), or by the issuer 201 and/or the seller 202 on their own behalf, from information collected by processing center 207 from a requester. In accordance with one or more embodiments, processing center 207 can be affiliated in some manner with seller 202 and/or 201. For example, processing center 207 can be independent or in some manner affiliated with (e.g., operated by) the issuer 201 and/or the seller 202. In accordance with one or more embodiments, processing center 207 can forward 223, to issuer 201, information relating to a gift card (e.g., deactivation/reactivation status) and/or a requester. Although not shown in FIG. 2, information can also be forwarded by processing center 207 to seller 202, such as information relating to a gift card (e.g., deactivation/reactivation status) and/or a requester.

Server 203 can comprise one or mores servers configured to provide an interface to the Internet, which interface can comprise one or more web pages accessible via the Internet. Using such an interface, a requester, e.g., purchaser 204 and/or recipient 206, can forward a request and receive confirmation as to the successful completion of the request (e.g., deactivation confirmation 217 or reactivation confirmation 220), or a failure notification.

In one or more embodiments presently disclosed, server 203 can comprise one or more servers configured to provide an interactive voice response, or IVR, computerized system, which allows the requester to make the request (e.g., the deactivation request 216 or the reactivation request 219) via a telephone. By way of a non-limiting example, the telephone caller can select options from a voice menu to interact with server 203, by way of pre-recorded voice prompts. Server 203 responds to one or more responses input by the requester to process the request. The caller's response(s) can be in the form of a verbal response, or a response entered using a keypad associated with the telephone device used by the caller, for example. Confirmations 214 and 217, or conversely denials, of a deactivation or reactivation (respectively) request can be forwarded to the requester via the IVR.

FIG. 3 is a schematic diagram illustrating components of a system for use in protecting a gift card used in commerce in accordance with one or more disclosed embodiments. In general, one or more embodiments of the present disclosure contemplate one or more computing devices, which can comprise one or more servers and one or more personal computing devices. In accordance with one or more embodiments, a system comprises one or more de(re)activation processing centers 311 configured to interact with one or more of a cardholder 310, a merchant 312 and an issuance/payment processing network 313 entity.

In accordance with one or more embodiments, processing center 311 can be affiliated with, or a part of, merchant 312 and/or issuance/payment processing network 313. In accordance with one or more alternate embodiments, processing center 311 is independent of merchant 312 and any entity in the issuance/payment processing network 313. In any case, processing center 311 can provide information collected in connection with card deactivation and/or reactivation to one or more of merchants 312 or issuance/payment processing network 313 entities. Collected information can be used to provide business intelligence to an interested party, including but not limited to seller 202, merchant 312 and/or an issuance/payment processing network 313 entity. For example, business intelligence can include information to identify a gift card transfer and demographic information associated with registered users, e.g., users registration performed as part of deactivation and/or reactivation.

Issuance/payment processing network 313 entity can include, for example, issuer 201 or another entity issuing a card to cardholder 310. In addition, the issuance/payment processing network 313 entity can include an entity involved in authorization, reconciliation or settlement of a transaction involving a gift card.

In accordance with one or more embodiments, the merchant 312 and the network 313 entity comprises computing systems that interface with processing center 311, which computing systems comprise a computing device, e.g., server 303, and a data store, e.g., database (or “DB”) 305. In addition, the cardholder 310 can access processing center 311 using a personal computer 301, for example. Communication links may be established between the various components (e.g., personal computers 301, merchant system 312 and issuance/payment network 313 and processing center 311. In one embodiment, these links may be wired and/or wireless and may or may not be dedicated. In one embodiment, for example, a component may access the website or interface for processing center 311 via the Internet, or other computing network that can be used to interconnect computing devices.

In accordance with one or more embodiments and by way of non-limiting examples, merchant 312 can be a gift card seller, e.g., seller 202, and/or merchant 312 can be an entity at which a gift card can be used in a transaction, e.g., a purchase transaction.

In accordance with one or more embodiments, processing center 311 of FIG. 3 corresponds to processing center 207 of FIG. 2, and server 303 and database 305 of processing center 311 correspond to server 203 and database 205, respectively, of FIG. 2. Server 303 and database 305 can comprise one or more instances of a server and a database, respectively. In accordance with one or more embodiments, server 303 comprises at least one computing device configured to respond to deactivation and reactivation requests, provide a status for a given gift card (e.g., in response to a request made in connection with an authorization operation performed as part of a gift card transaction), and/or provide information about a requester and/or other information associated with a gift card maintained in database 305.

Server 303 can be accessed, e.g., via the Internet, by one or more cardholders 310 using a personal computer 301, for example. In the example shown in FIG. 3, while the cardholder 310 is shown to interface with the processing center 311, merchant 312 and/or the network 313 entity via a personal computer 301, it should be apparent that the cardholder 310 can use other devices, even non-computing devices, as an interface with the processing center 311, merchant 312 and/or the network 313 entity. By way of a further non-limiting example, the cardholder 310 might interact with processing center 311 using another type of device, including a telephone (e.g., a smart telephone, touch tone telephone, etc.). As discussed above, a cardholder 310 can request deactivation and/or reactivation of a gift card. In accordance with one or more embodiments, a deactivation request is performed as part of a registration, e.g., registration/deactivation 322, in which the cardholder registers with processing center 311. As part of registration, the cardholder 310 may be asked to provide personal and/or demographic information.

In accordance with one or more embodiments, a registration process can be used as part of a reactivation request, e.g., registration/reactivation 324, whereby a reactivation requester can be asked for personal and/or demographic information. A reactivation requester, e.g., a cardholder 310 who forwarded a gift card to a recipient or the recipient, can use personal computer 301, or other type of device, to interface with processing center 311, to reactivate a deactivated gift card.

In accordance with one or more embodiments, processing center 311 might provide offers/support 323 to a cardholder. For example, after authentication of a cardholder, processing center 311 might provide information on the status of a card, and/or reactivation information (e.g., in a case that the reactivation information was forgotten by the cardholder). In addition, processing center 311 may make various offers to a cardholder on behalf of the processing center 311, an issuer (e.g., issuer 201), point-of-sale/seller 202, merchant 312, and/or an issuance/payment processing network 313 entity, or a partner of any one of these entities or parties. The cardholder 310 might also access the network 313 entity, e.g., the gift card issuer 201, to request support 326 (e.g., obtain available funds balance, “reload” the gift card balance, etc.).

In accordance with one or more embodiments, the processing center 311 can provide information 321 on the gift card (e.g., status information) and/or information on a cardholder (e.g., information acquired by the processing center 311 during registration) to a merchant 312, or provide such information 328 to an entity in the issuance/payment network 313 (e.g., the gift card issuer 201), such that the merchant 312 or network 313 entity can make offers, 325 and 326 (respectively), to a gift card holder. Providing such information to the merchant 312 and/or the network 313 entity can act as an incentive to the merchant 312 and/or the network 313 entity to participate in the gift card protection provided in accordance with one or more disclosed embodiments.

In addition, one or more embodiments presently disclosed can be used to detect unauthorized use of a gift card, thereby minimizing fraud, which provides a further incentive for cardholders 310, merchants 312 and network 313 entities to participate in the gift card protection provided in accordance with one or more disclosed embodiments.

By way of a non-limiting example, in the course of a transaction involving a gift card, a merchant 312 can provide authorization information (e.g., the gift card's number, transaction authorization PIN, cardholder's identification information, etc.) to issuance/payment network 313 as part of purchase transaction(s) 327. In accordance with one or more embodiments, network 313 accesses information on the activation status provided by processing center 311. The activation status may have been provided by processing center 311 prior to receiving the purchase transaction(s) 327 from the merchant 312, for example. Alternatively, and by way of another non-limiting example, issuance/payment network 313 can request status information from processing center 311 in response to receipt of a purchase transaction(s) 327 from the merchant 312. In any case, information on the activation status of the gift card supplied by processing center 311 can be used to determine whether or not to authorize use of the gift card in the purchase transaction(s) 327 presented to the network 313 by the merchant 312.

In a case that the information supplied by processing center 311 indicates that the gift card is currently deactivated, authorization can be denied. By way of a further non-limiting example, in a case that the information supplied by processing center 311 indicates that the gift card is currently activated, the information supplied by processing center 311 can be used, together with other information (e.g., available funds, etc.) to determine whether to authorize the transaction. Thus, the information collected and supplied by processing center 311 can greatly reduce the potential for fraudulent use of a gift card, which is beneficial to all parties, e.g., the cardholder 310, the merchant 312 and the network 313 entity. Since the information collected and supplied by processing center 311 can be used to identify fraudulent use of a gift card, loss associated with fraudulent use of a gift card can be decreased, which will increase goodwill between the parties.

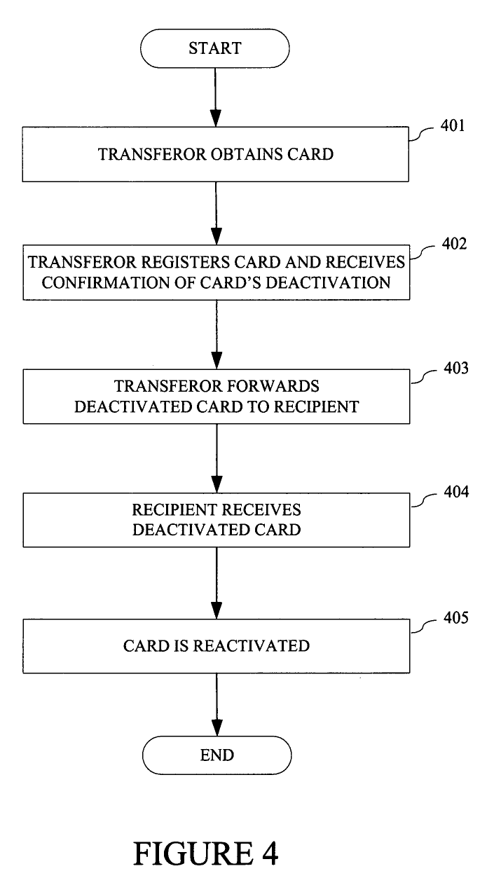

FIG. 4 is a flow diagram illustrating process steps for transferring a card protected in accordance with one or more disclosed embodiments. At step 401, the transferor obtains the gift card. In accordance with one or more embodiments, the transferor can be the original purchaser of the gift card. In accordance with alternative embodiments, the transferor can be a transferee, such as the recipient of the card from the original purchaser, or other transferee.

At step 402, the transferor registers the gift card and receives confirmation of the card's deactivation. In accordance with one or more embodiments, the confirmation includes the reactivation information (e.g., password, pass code, etc.) for use in authenticating a reactivation request. In accordance with at least one embodiment, the reactivation information is assigned, or otherwise set, by the deactivation requester, the transferor in the example shown in FIG. 4. In accordance with at least one alternate embodiment, the reactivation information is assigned, or otherwise set, by the computer system, e.g., server 203, in response to the deactivation request.

At step 403, the transferor forwards the deactivated card to the recipient. As is discussed in more detail below, the status of the card, e.g., whether or not it is activated or deactivated, can be examined to determine whether or not to authorize a transaction (e.g., a purchase or other finds allocation) in which the card is used. Thus, by deactivating the card prior to its transfer, the card is less vulnerable than if the card was transferred without first being deactivated.

At step 404, the recipient receives the deactivated card. The card is then reactivated at step 405. In accordance with one or more embodiments, the recipient reactivates the card using information received from the transferor, or from a computing device, such as server 203. The reactivation information can be forwarded to the recipient in an electronic mail message, or via regular mail, for example. For purposes of further securing the transfer, the reactivation information can be sent separate from the card itself, and/or the reactivation information can be encrypted. As one alternative to the recipient reactivating the card, the transferor can reactivate the card, e.g., once the recipient informs the transferor that the card reached the recipient.

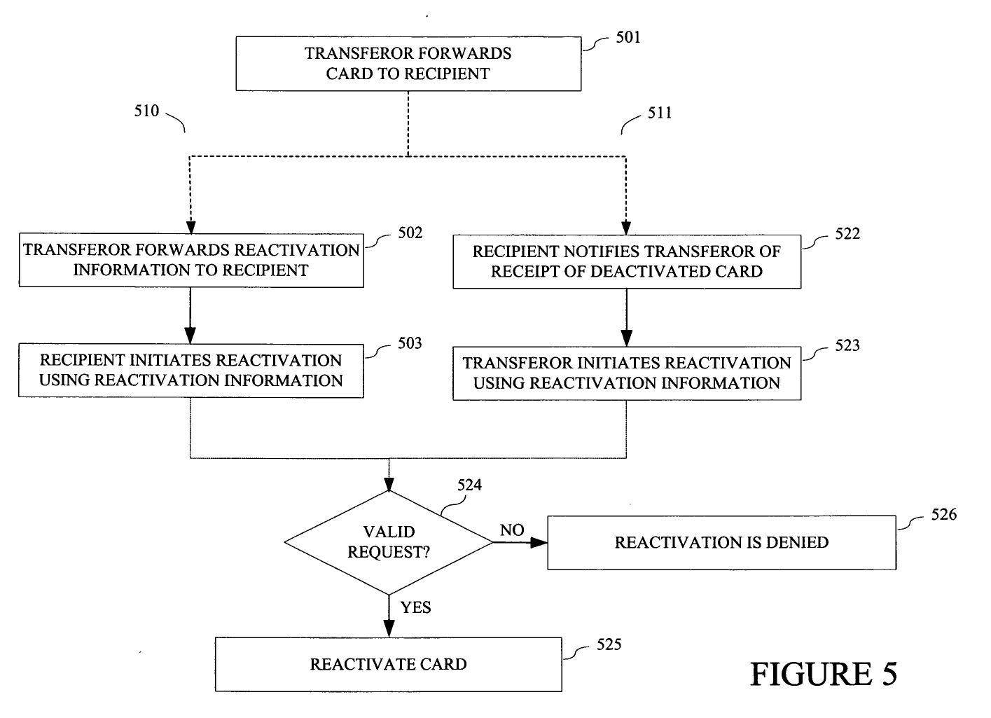

FIG. 5A provides an example of process steps for use in reactivating a deactivated card in accordance with one or more embodiments of the present application. Step 501 of FIG. 5A corresponds with step 403 of FIG. 4. Paths 510 and 511 correspond to a reactivation request initiated by the recipient and a reactivation request initiated by the transferor, respectively.

Following the process steps of path 510 and at step 502, the transferor forwards the reactivation information to the recipient. As discussed above, the reactivation information includes authentication information (e.g., a password, pass code, etc.) for use in authenticating the reactivation requester. Other information for use in authenticating the reactivation requester can include, but is not limited to, name, address, birth date, social security number, etc. In accordance with one or more embodiments, with respect to either one or both of the deactivation and reactivation requests, information can be required for the deactivation requester, the reactivation requester, or both, at least for purposes of authenticating a request. At step 503, the recipient uses the reactivation information in a request to reactivate the card.

It will be appreciated that the recipient may request reactivation of the card at any time and from a variety of locations. For example, the recipient might request reactivation of the card as soon as it is received. However, the recipient might wait and reactivate the card when the recipient is ready to use the card. Also, the recipient might request reactivation of the card from their home or office, or in one or more embodiments, at a retailer or other location where the card is to be used (i.e. the recipient could request reactivation at the time the card is to be used at a retailer's location).

Following the process steps of path 511 and at step 522, the recipient notifies the transferor that the recipient received the deactivated card. At step 523, the transferor uses the reactivation information in a request to reactivate the card.

Paths 510 and 511 both flow to steps 524. At steps 524 to 526, the authentication information, which includes the reactivation information, received from the recipient or the transferor is examined to determine whether the request is a valid, authentic reactivation request. If the received reactivation request is valid, the card is reactivated at step 525. If the reactivation information is invalid, the reactivation request is denied, at step 526.

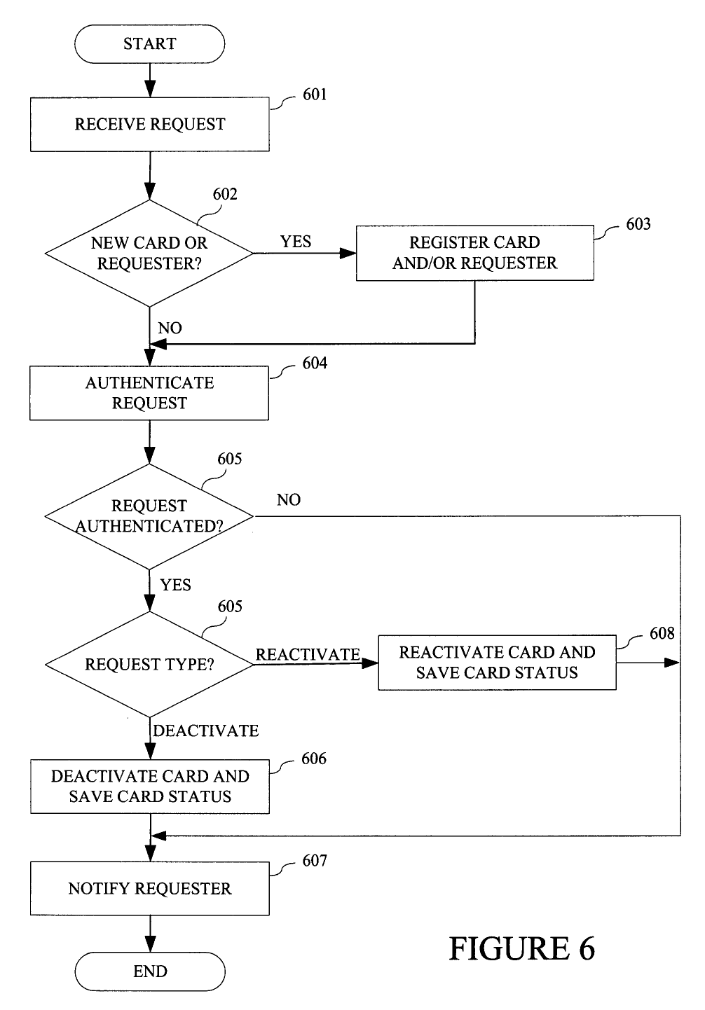

FIG. 6 is a flow diagram illustrating process steps for use by a computing device, e.g., server 203 of processing center 207, in response to a deactivation or reactivation request in accordance with one or more embodiments of the present disclosure. At step 601, a request, e.g., a deactivation request or a reactivation request, is received. In accordance with one or more embodiments, a deactivation request and/or a reactivation request includes registration of a card and/or a cardholder. For example, in a case that a card is purchased and the request is submitted at the time or purchase, a request to deactivate the card can include registration of the card and the purchaser. By way of another non-limiting example, a recipient can register as the new cardholder with a request to reactivate the card. At step 602, a determination is made whether the request is for a new card or a new requester. If so, processing continues at step 603 to register the new card and/or requester. A new card can be a card that has not yet been processed by the server 203, for example. In the case of a new card, the registration can include the card's number, and any validation number associated with the card, for example. Other non-limiting examples of card information can include expiration date, amount of available funds, date of purchase, date of transfer, and the like. In addition to card information, one or more disclosed embodiments contemplate registering a cardholder, or future cardholder. In a case of a purchaser who transfers the card to a recipient, the cardholder information can include information about the purchaser and/or the recipient.

At step 604, the request is authenticated. As is described below, the authentication performed can depend on the type of request, e.g., a deactivation or reactivation request. At step 605, a determination is made whether or not the request is successfully authenticated. If authentication fails, processing continues at step 607 to notify the requester. If authentication is successful, processing continues at step 605 to process the request based on the type of request. If the request is a reactivation request, processing continues at step 608 to reactive the card, which includes saving a reactivation status for the card. If the request is a deactivation request, processing continues at step 606 to deactivate the card, which includes saving a deactivation status for the card. For example, in steps 606 and 608, the status of the card is saved in an entry in database 205 of processing center 211, in an entry associated with identifying information for the card, e.g., some or all of card number, validation number, cardholder, expiration date, etc.

Regardless of the type of request or outcome of the determination made at step 605, processing continues from either step 606 or step 608 to step 607, to notify the requester. The notification can confirm that the request, e.g., the deactivation request or reactivation request, completed successfully, for example. In addition, in a case of a deactivation request, the notification can confirm the reactivation information needed to reactivate the card. In a case that a request cannot be authenticated, or otherwise validated, the notification can confirm that the request was not successfully completed.

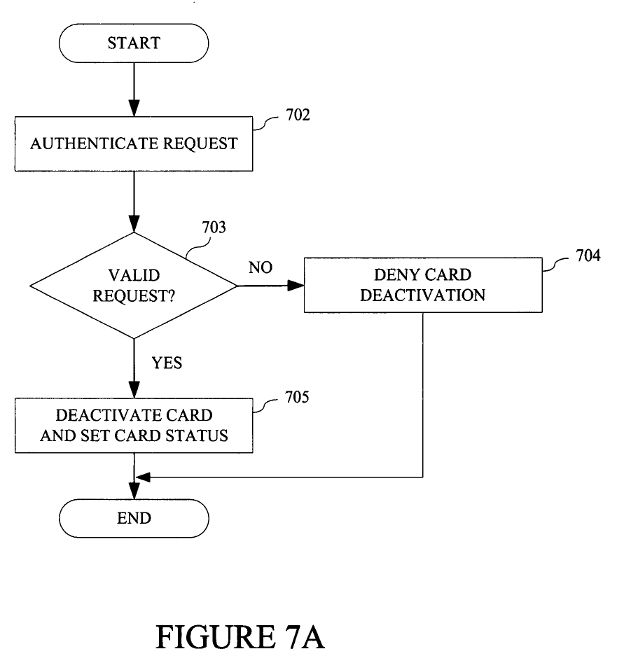

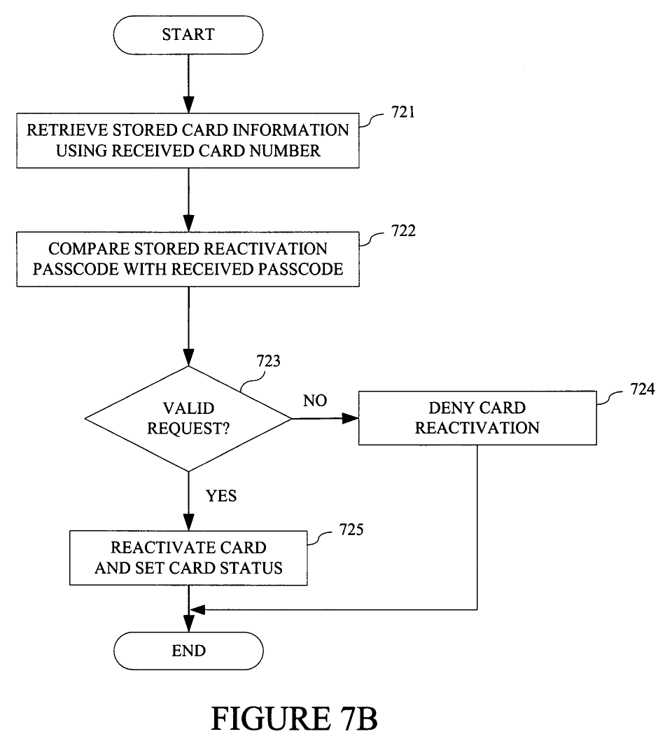

In accordance with one or more embodiments of the present disclosure, a request to deactivate, a request to reactivate or both can be validated, or authenticated. FIG. 7, which comprises FIGS. 7A and 7B, is a flow diagram illustrating process steps for use in authenticating a deactivation request and a reactivation request in accordance with one or more embodiments of the present disclosure.

Referring to FIG. 7A, a flow diagram illustrates process steps for use in authenticating a deactivation request. At step 702, which corresponds with step 604 of FIG. 6, authentication is performed in response to a request to deactivate a card. Authentication can comprise validation of the request, card information and/or requester information. For example, a request to deactivate a card can validate the card's identifying numbers, e.g., the card number and any validation number. To validate the card number, embodiments of the present disclosure can determine whether the number has a valid format. If information is available from the card's issuer, such as the card number, validation number and/or cardholder information, validation can comprise a comparison of the issuer's card information against the information associated with the requester, e.g., card number, card validation number, card expiration date, cardholder information (e.g., name, address, birth date, etc.). In accordance with one or more embodiments, a check can be made of database 205, to determine whether one or more entries exist for the identified card. If so, validation can include a comparison of the card information in the request with the stored card information and/or stored requester information.

At step 703, a determination is made whether authentication of the deactivation request is successful. If not, the deactivation request is denied at step 704. If, however, authentication is successful, processing continues at step 705 to set the status of the card as deactivated and to store the status of the card in database 205.

Referring to FIG. 7B, a request to reactivate a card is authenticated. In accordance with embodiments presently disclosed, a reactivation request comprises card identification and reactivation information for use in authenticating the reactivation request. At step 721, database 205 is accessed to retrieve a card's stored information using information, e.g., card number, contained in the reactivation request. The stored information comprises the reactivation information. The stored reactivation information is compared with the received reactivation information at step 722. If a determination is made, at step 723, that the stored reactivation information and receive information do not correspond, processing continues at step 724 to deny the request to reactivate the card. If the stored reactivation information and the received information correspond, processing continues at step 725 to reactivate the card by setting the status of the card to an activated status and storing the status of the card in the database 205.

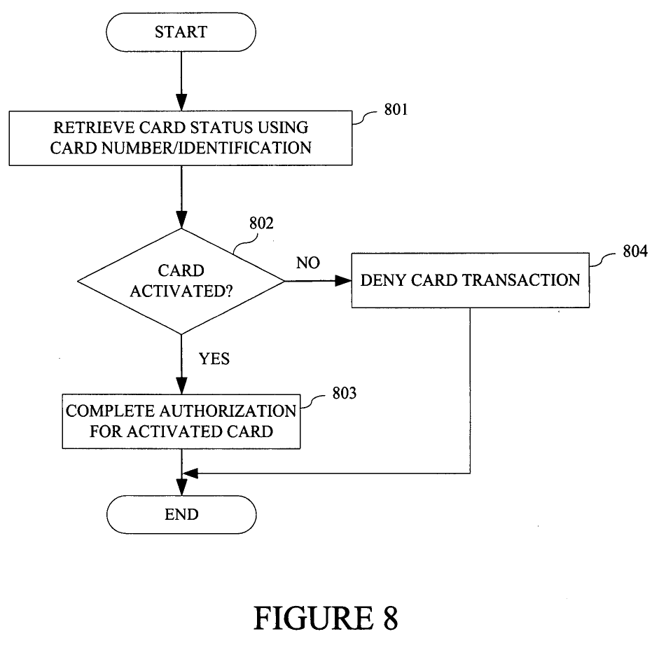

In accordance with embodiments of the present disclosure, FIG. 8 is a flow diagram illustrating processing steps for use in authorizing a transaction involving a card using a card status set in accordance with one or more embodiments of the present disclosure.

At step 801, a card's status is retrieved from database 205 using the card identification used in the transaction, e.g., card number with a validation number, if any. At step 802, a determination is made whether or not the card is in an activated state. If not, processing continues at step 804 to deny the card transaction. Denial can be in the form of a response, which identifies the deactivated status of the card. In such a case, for example, the response can be used by one or more entities in the network 313 to deny the transaction. Alternatively, denial can be a denial of the transaction, for example. As indicated above, in one embodiment, the requestor could be permitted to request reactivation at the time the card is used, including after a denial indicating that the status of the card is deactivated.

If it is determined, at step 802, that the card is in an activated status, this information can be used, at step 803, as part of authorizing the transaction in which the card is used. Thus, in accordance with embodiments presently disclosed, an activated/deactivated status of a card can be examined as part of an authorization process performed in connection with a transaction in which the card is used, e.g., a purchase or other attempt to access available funds for the card. In accordance with one or more embodiments, such a transaction can comprise any transaction in which an amount is to be debited from the available funds associated with a card. In accordance with one or more embodiments, a transaction can involve a credit of some sort, e.g., a merchandise return, a balance reload, etc.

While the method has been described with reference to particular steps, it should be appreciated that a variety of other steps may be associated with protection of a card, such as a gift card, and the steps described above need not be completed in the order in which they were described. Further, the method might comprise other or additional steps. It will also be appreciated that other systems than described above may be configured to implement the one or more embodiments of the present disclosure. In addition, in accordance with one or more embodiments, program code embodying the above-described steps, or other steps, performed in connection with deactivation and/or reactivation of a gift card can be stored on a computer-readable medium.

Furthermore, in accordance with one or more embodiments, a computer-readable medium can comprise program code for use with one or more computing devices to provide card protection in accordance with one or more embodiments of the present disclosure. A computing device can include, but is not limited to, a server, client computer, mobile computing device, or any other device (telephone, personal data assistant, etc.) having, or coupled to a computing device. In accordance with one or more embodiments, a computing device comprises one or more processors, storage, input device (e.g., keyboard, mouse, etc.), modem and/or network interface. Of course, it should be apparent that a computing device can comprise other components, such as a reader or other interface to retrieve program code stored on a computer-readable medium.

The systems and methods of the present disclosure have numerous advantages over the current process for gift card usage. First, the system and method permits a cardholder to safeguard a card for some period of time, such as a period of time during which a card is being transferred from one cardholder to another. To further illustrate, embodiments of the present disclosure can be used by a cardholder to safeguard a card for an anticipated period of inactivity. In any case, embodiments of the present disclosure can be used to deactivate a card. By deactivating the card, the card can be protected from unauthorized use.

By way of further non-limiting example of the advantages, embodiments of the present disclosure provide a level of visibility into cardholders, from the original purchaser to transferees. The increased visibility can be used by various entities to customize offers and support provided to a cardholder. The increased visibility can be used to authenticate a request made in connection with a card, including a request to deactivate or reactivate a card.

It will be understood that the above described arrangements of the system and method therefrom are merely illustrative of applications of the principles of this invention and many other embodiments and modifications may be made without departing from the spirit and scope of the invention as defined in the claims.

I claim:

1. A method for protecting a stored-value instrument used to access a balance of funds associated with the instrument, the method comprising steps of:
in response to a request to deactivate a stored-value instrument, performing the steps of:
setting a deactivated status for the instrument;
assigning reactivation information for use in reactivating the deactivated instrument;
in response to a request to reactivate the deactivated instrument, performing the steps of:
determining whether reactivation information received with the reactivation request corresponds with the reactivation information assigned in deactivating the instrument;
setting an activated status for the instrument in a case that a determined correspondence exists between the assigned and received reactivation information.

2. The method of claim 1, wherein said steps performed in response to a request to deactivate an activated instrument and/or said steps performed in response to a request to reactivate a deactivated instrument further comprise a step of:
obtaining information about a requester.

3. The method of claim 2, further comprising the steps of:
using the obtained information to make one or more offers to the requester.

4. The method of claim 2, further comprising the steps of:
forwarding the obtained information to an instrument issuer or other party.

5. The method of claim 2, wherein said step of obtaining information about a requester is performed during a registration of the requester.

6. The method of claim 1, wherein the deactivation and reactivation requests are made by a same requester.

7. The method of claim 1, wherein the requester is the instrument's purchaser, and the deactivation request occurs at a time that the instrument is purchased.

8. The method of claim 1, wherein the deactivation and reactivation requests are made by different requesters.

9. The method of claim 1, wherein the deactivation request is made by a first holder of the instrument and the reactivation request is made by a second holder of the instrument.

10. The method of claim 9, wherein the first instrument holder is an original purchaser of the instrument, and wherein the original purchaser transfers the instrument to the second instrument holder.

11. The method of claim 9, wherein the deactivation and reactivation requests are received from the first instrument holder.

12. The method of claim 9, wherein the deactivation request is received from the first instrument holder and the reactivation request is received from the second instrument holder.

13. The method of claim 1, wherein the deactivation request, the reactivation request, or both are received by a server accessible via a computer network.

14. The method of claim 1, wherein the deactivation request, the reactivation request, or both are received via an interactive voice response computerized telephone system.

15. The method of claim 1, wherein the stored-value instrument is a gift card.

16. A system for protecting a stored-value instrument used to access a balance of funds associated with the instrument, said system comprising:
one or more computing devices running a machine executable code, said code configured to:
in response to a request to deactivate a stored-value instrument, perform the steps of:
setting a deactivated status for the instrument;
assigning reactivation information for use in reactivating the deactivated instrument;
in response to receipt of a request to reactivate the deactivated instrument, perform the steps of:
determining whether reactivation information received with the reactivation request corresponds with the reactivation information assigned in deactivating the instrument;
setting an activated status for the instrument in a case that a determined correspondence exists between the assigned and received reactivation information.

17. The system of claim 16, wherein said code further comprises code performed in response to either a request to deactivate an instrument or a request reactivate a deactivated instrument, the code configured to:
obtain information about a requester.

18. The system of claim 17, said code is further configured to:
use the obtained information to make one or more offers to the requester.

19. The system of claim 17, said code is further configured to:
forward the obtained information to an instrument issuer or other party.

20. The system of claim 17, wherein information about a requester is obtained during a registration of the requester.

21. The system of claim 16, wherein the deactivation and reactivation requests are made by a same requester.

22. The system of claim 16, wherein the requester is the instrument's purchaser, and the deactivation request occurs at a time that the instrument is purchased.

23. The system of claim 16, wherein the deactivation and reactivation requests are made by different requesters.

24. The system of claim 16, wherein the deactivation request is made by a first holder of the instrument and the reactivation request is made by a second holder of the instrument.

25. The system of claim 24, wherein the first instrument holder is an original purchaser of the instrument, and wherein the original purchaser transfers the instrument to the second instrument holder.

26. The system of claim 24, wherein the deactivation and reactivation requests are received from the first instrument holder.

27. The system of claim 24, wherein the deactivation request is received from the first instrument holder and the reactivation request is received from the second instrument holder.

28. The system of claim 16, wherein the deactivation request, the reactivation request, or both are received by a server accessible via a computer network.

29. The system of claim 16, wherein the deactivation request, the reactivation request, or both are received via an interactive voice response computerized telephone system.

30. The system of claim 16, wherein the stored-value instrument is a gift card.
